(19) United States
(12) Patent Application Publication
(10) Pub. No.: US 2019/0048542 A1
(43) Pub. Date: Feb. 14, 2019

(54) PORTABLE POP-UP SAFETY SIGN OR BARRICADE

(71) Applicant: Robert LIBROIA, II, Flushing, NY (US)

(72) Inventor: Robert LIBROIA, II, Flushing, NY (US)

(21) Appl. No.: 16/102,818

(22) Filed: Aug. 14, 2018

Related U.S. Application Data
(60) Provisional application No. 62/545,026, filed on Aug. 14, 2017.

(51) Int. Cl. E01F 9/692; G09F 15/00; E01F 9/646; E01F 13/02

(52) U.S. Cl. CPC E01F 9/692; E01F 13/02; E01F 9/646; G09F 15/0062

(57) ABSTRACT

An apparatus for partitioning a space, comprising a one or more panels arranged as a collapsible assembly; and a set of fasteners for removable attachment of the one or two of the panels to a structure so as to partition off the space in front of the structure. Each fastener can include at least one tab extending from an edge of a first of the plurality of fasteners; and at least one tab extending from an edge of a second of the plurality of fasteners; wherein each tab includes a magnetized material for removable attachment to the structure. A plurality of suction cups can be provided for removable attachment to the structure, each suction cup including a magnetic material; wherein each tab includes a magnetized material for removable attachment to a suction cup. A fabric fastener can be used for attachment of the section cups and tabs. An elastic band can maintain the apparatus in a collapsed configuration.

This application claims priority from and the benefit of provisional application Ser. No. 62/545,026 filed on Aug. 14, 2017, which is incorporated herein by reference, in its entirety.

### BACKGROUND OF THE DISCLOSURE

### 1. Field of the Disclosure

The present disclosure relates to safety signs. More particularly it relates to a safety sign that can be used to warn and block people from attempting to enter an area, including the area associated with elevator doors when the elevator is being repaired.

### 2. Description of the Related Art

Conventional safety signs or barricades for elevators, such as those used in front of elevator doors when elevators are being repaired, are heavy and bulky and difficult to secure in place to provide protection to the public.

There is a need for a sign or barricade that is light in weight, easy to transport and readily affixed in place in front of elevator doors.

### SUMMARY OF THE DISCLOSURE

In general, an embodiment of the disclosure is directed to an apparatus for partitioning a space, comprising at least one, but generally, a plurality of panels arranged as a collapsible assembly; and a set of fasteners for removable attachment of one or two of the panels to a structure so as to partition off the space in front of the structure. Each fastener can include at least one tab extending from an edge of a first of the plurality of fasteners; and at least one tab extending from an edge of a second of the plurality of fasteners; wherein each tab includes a magnetized material for removable attachment to the structure. The apparatus may include a plurality of suction cups for removable attachment to the structure, each suction cup including a magnetic material; and wherein each tab includes a magnetized material for removable attachment to one of the suction cups. An elastic band can maintain the apparatus in a collapsed configuration.

Fabric fasteners can be used to with the suction cups. One or more loops can be provided at the bottom of the apparatus for engaging a stake in the ground, or similar structure.

### BRIEF DESCRIPTION OF THE DRAWINGS

FIG. 1 is a perspective view from the back of a barricade in accordance with disclosure.

FIG. 2 is a front to side perspective view of the barricade of FIG. 1.

FIG. 3 is a front view of the barricade of FIG. 1.

FIG. 4A to FIG. 4G, wherein FIG. 4E is an enlarged portion of FIG. 4D, and FIG. 4G is an enlarged portion of FIG. 4F, illustrate the manner of deploying and using the barricade of FIG. 1.

FIG. 5A to FIG. 5E illustrate of the manner of collapsing and securing the barricade of FIG. 1.

FIG. 6 is an illustration of the barricade of FIG. 1 in a collapsed and secured state.

FIG. 7 is a perspective view illustrating the addition of a member to assist in stabilizing a barricade disclosed herein.

A component or a feature that is common to more than one drawing is indicated with the same reference number in each of the drawings.

### DESCRIPTION OF THE EMBODIMENTS

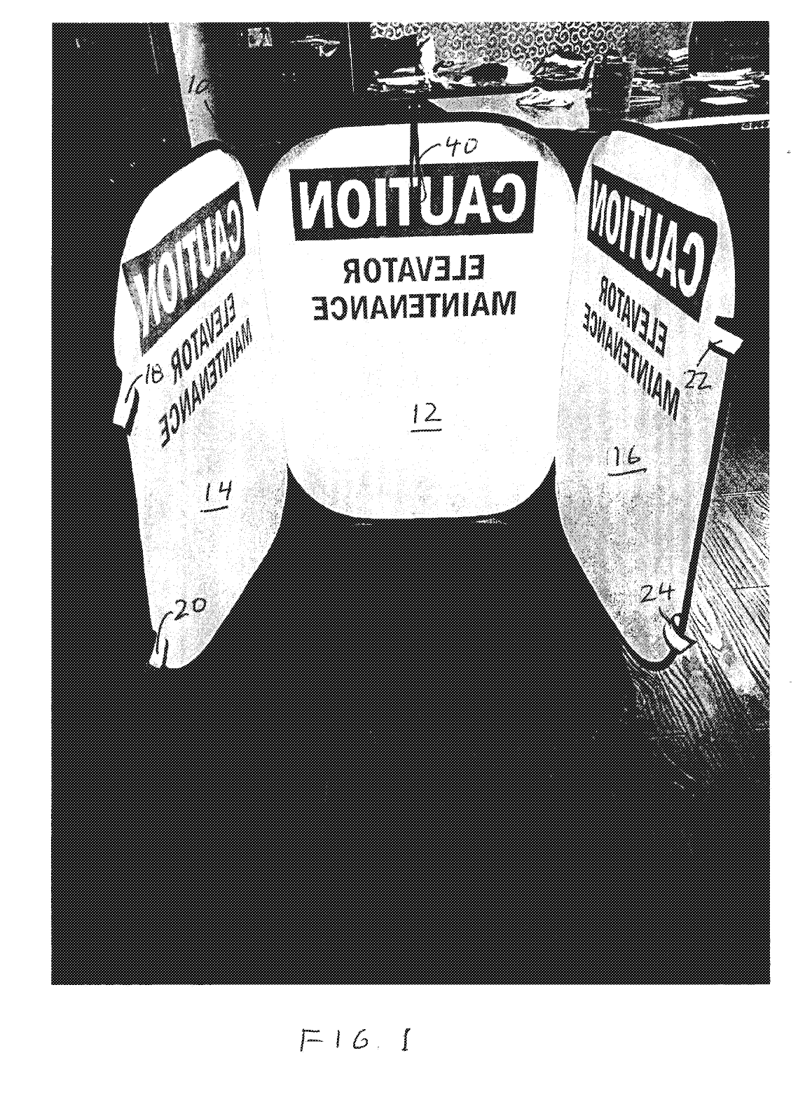

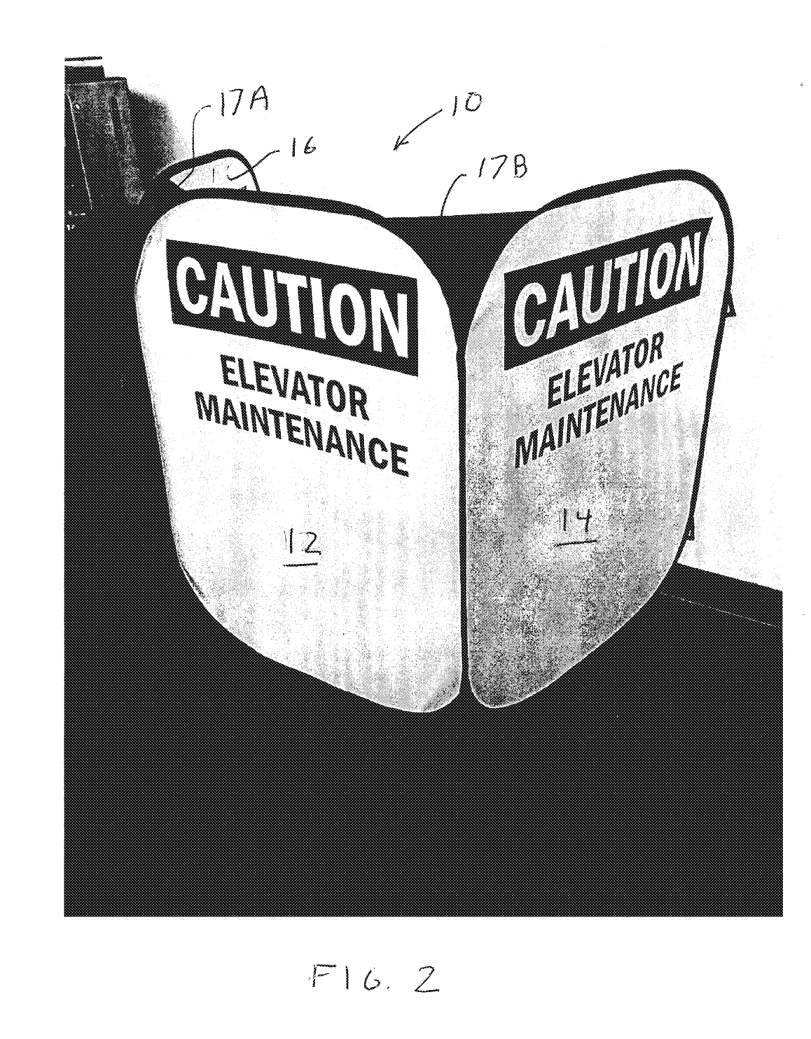

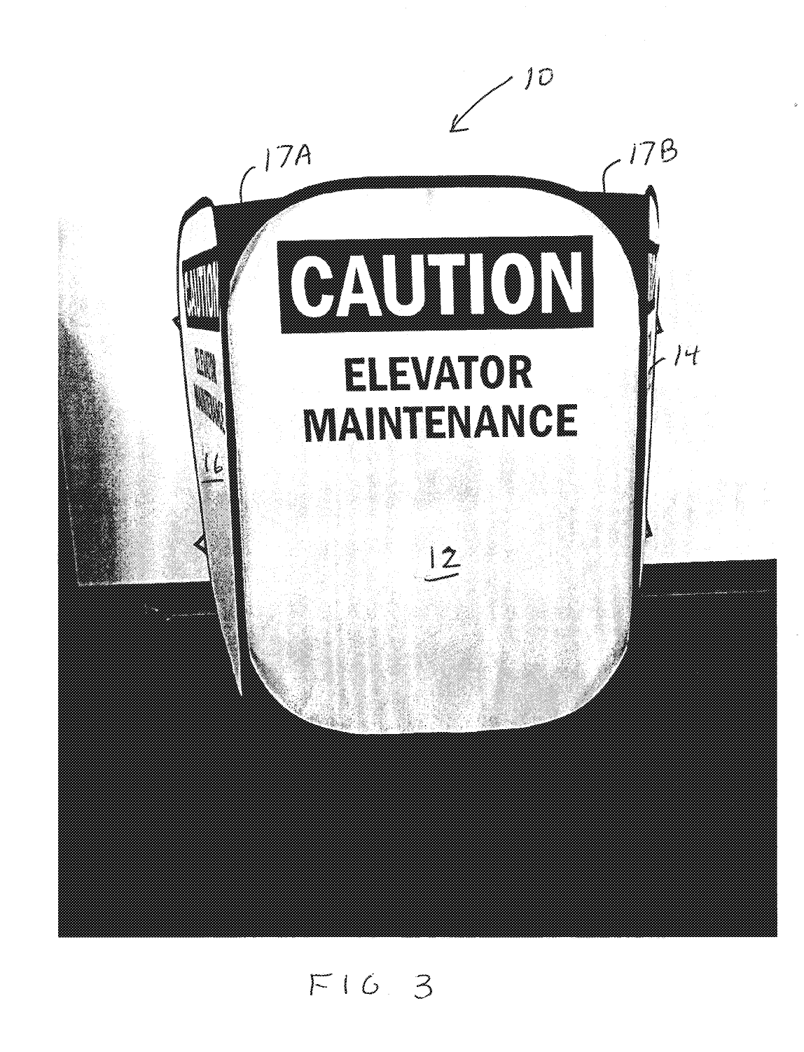

Referring to FIGS. 1, 2 and 3, a barricade or sign 10 as disclosed herein is illustrated. Sign or barricade 10 is formed with a front panel 12, a first side panel 14 and a second side panel 16. Each of panels 12, 14 and 16 is formed of a flexible material, such as a thin polyester with a rim that receives a plastic or metal stiffening member (not shown). This type of construction is well known from, for example, U.S. Pat. No. 5,964,533 to Ziglar and U.S. Pat. No. 7,080,653 to Zheng.

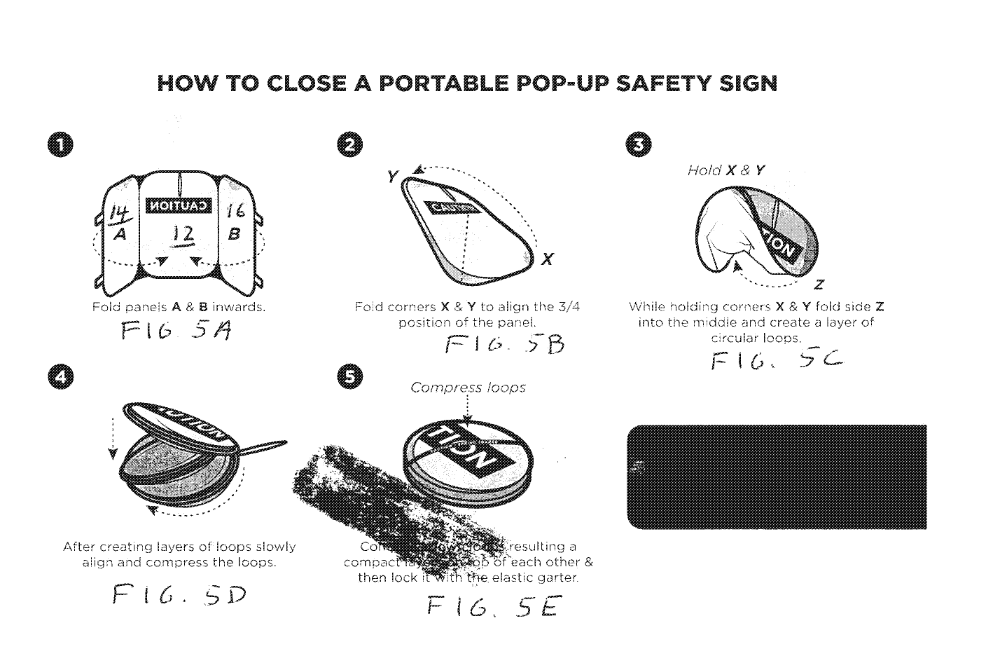

Panels 12 and 14 are hinged to one another along a common edge. Panels 12 and 16 are also hinged to one another along a common edge. As explained below with respect to FIG. 5, this permits panels 14 and 16 to be folded over panel 12. Panels 12, 14 and 16 may have curved corners. Webs of flexible material 15A and 15B may connect the curved portions of panels 12 and 14. Webs of flexible material 17A and 17B may connect the curved portions of panels 12 and 16.

Panel 14 has, along an edge opposite to the one hinged to panel 12, two fabric tabs 18 and 20. Panel 16 also has, along an edge opposite to the one hinged to panel 12, two fabric tabs 22 and 24.

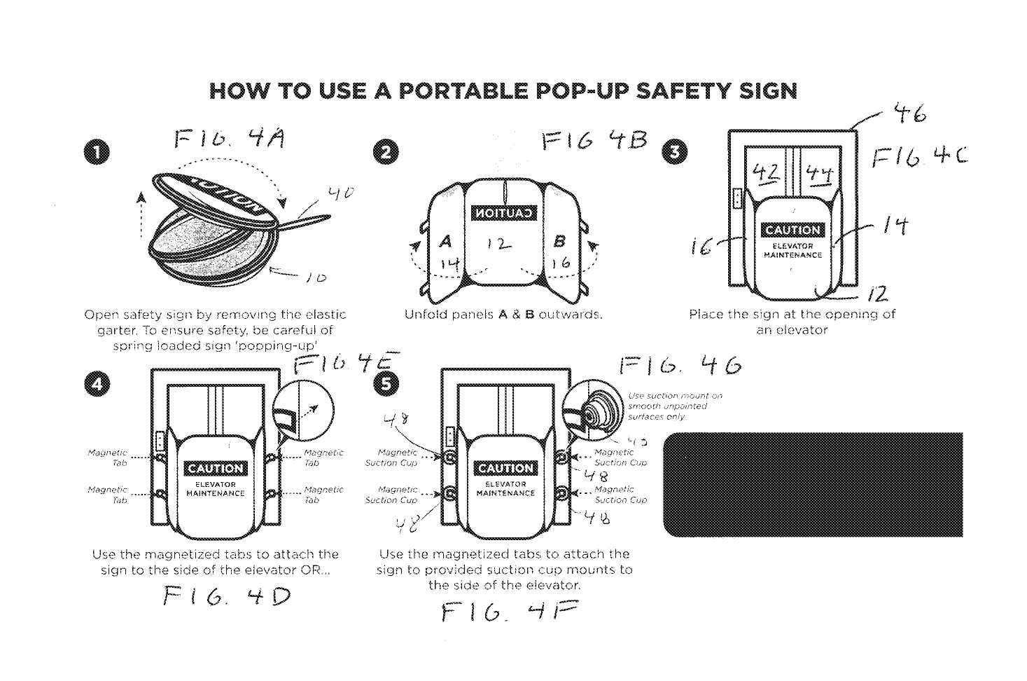

In FIG. 4A, the sign 10 is shown being deployed from a collapsed state in which it is secured by an elastic band 40. When the band 40 is removed, the sign will expand and pop up. After the sign has popped up, the panels 14 and 16, which were folder over panel 12, are unfolded, as shown in FIG. 4B. In FIG. 4C, the unfolded sign 10 is placed in front of the doors 42 of an elevator buck or door frame 46.

In FIG. 4D, the tabs 18 and 20 are secured to a first side of door frame 46, while tabs 22 and 24 are secured to a second side of door frame 46. Tabs 18, 20, 22 and 24 may include a magnetized metallic strip that is attracted to and secured upon door frame 46, as illustrated, for example, in FIG. 4E. FIG. 4F illustrates an alternative wherein, as best illustrated in FIG. 4G, suction cups 48 may be attached to smooth surfaces of door frame 46 at positions corresponding to where tabs 18, 20, 22 and 24 may be located to attach sign 10 to door frame 26 in a removable manner. Each of suction cups 48 may have a magnetic material therein, such as a ferrous material, that attracts a respective one of tabs 18, 20, 22 and 24 to secure sign 10 in place in a removable manner. Suction cups 48 are especially useful in cases where tabs 18, 20, 22 and 24 are not magnetically attracted the door frame 46, such as when door frame is formed of a non-magnetic material or is covered by an unduly thick coat of paint. Alternatively, a fabric fastener, such as Velcro® may be used on the section cups 48 and tabs 18, 20, 22 and 24 to allow them to be temporarily fastened together, as needed. A portion of the fabric fastener may be in the form of a loop. Alternatively, a first cord may be attached to the suction cup and a second cord attached to the sign, and the cords may be tied together, preferably in a fashion that can be released, to keep the sign in place while it is needed. Alternatively, one of the cords may also be attached directly to the portion of the structure to which the sign is to be fastened.

At such time that it is desirable to remove and store sign 10 from deployment in front of elevator frame 46, it is simply pulled away so that tabs 18, 20, 22 and 24 are no longer in contact with door frame 46 or respective suction cups 48. When suction cups 48 have been deployed, they too can be released from frame 48 by simply pulling them off. Suction cups 48 may then be stored for later use with sign 10.

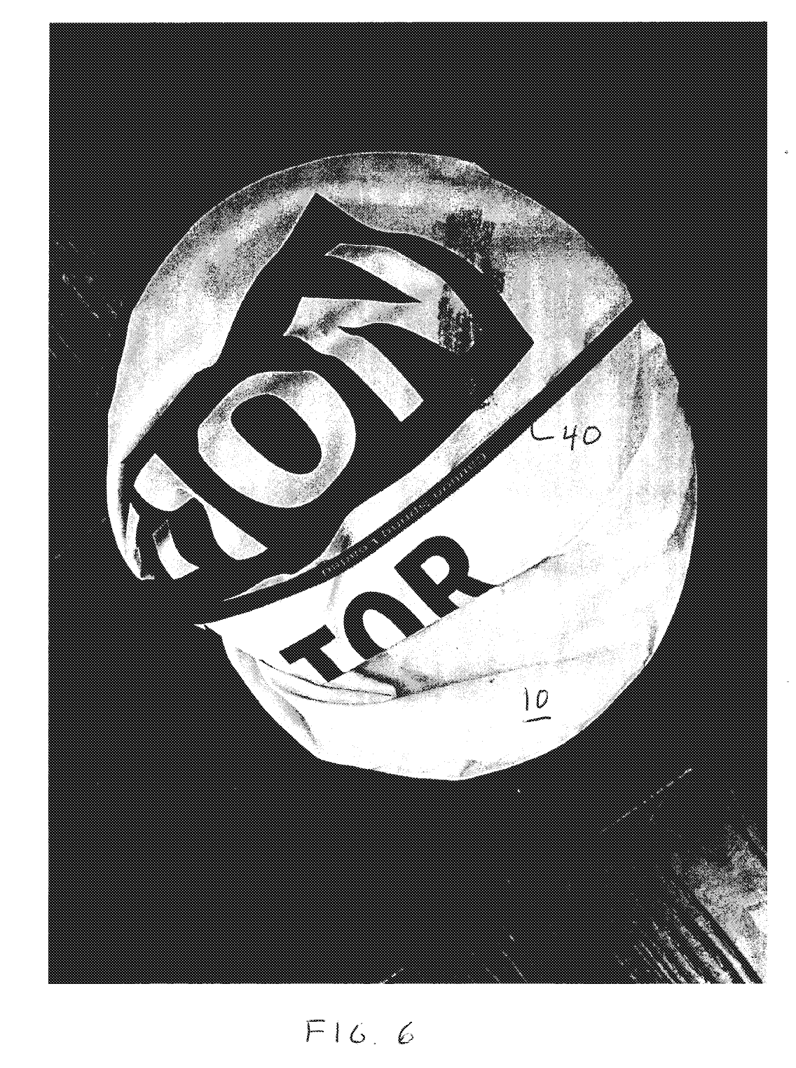

FIGS. 5A to 5E illustrate the manner of collapsing and storing sign 10 for later use, after it has been removed from a door frame 46. In FIG. 5A, panels 14 and 16 are folder over panel 12. In FIG. 5B, corners X and Y are folder toward one another. In FIG. 5C, while corners X and Y are held together, side Z is folder into the center to create a layer of circular loops. In FIG. 5D, the created loops are aligned and compressed. In FIG. 5E, after the loops have been compressed to form a flat pancake shaped structure, the elastic band 40 is used to hold the resulting structure in a compressed state. FIG. 6 illustrates the sign 10 being held in its collapsed configuration by the band 40.

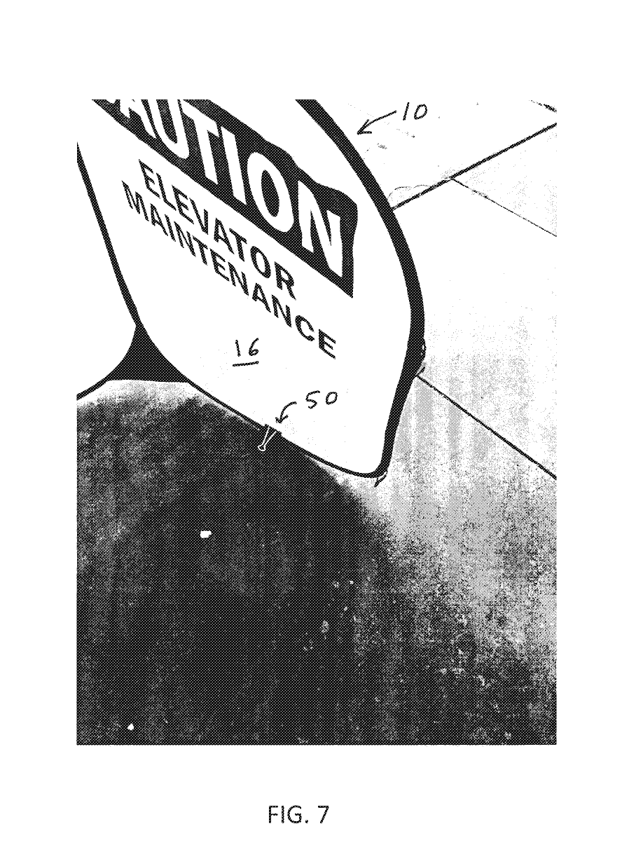

FIG. 7 illustrates an attachment for stabilizing the barricades disclosed herein. A member, such as a binder clip 50, with its generally rectangular surface facing downward touching the surface or floor on which barricade 10 is positioned, is affixed to panel 16, by squeezing binder clip 50 open and allowing it to close and affix itself to panel 16 as shown. Other stabilizing members may be used, such as any planar member having a bottom surface which contacts the floor and perpendicular to that surface, another surface parallel to that of panel 16, and affixed thereto. Such stabilizing members may be affixed to each of panels 12, 14 and 16, or may be removable for subsequent reuse at any time that a barricade 10 is erected for use.

In order to secure sign or barricade 10 in place, self attached suction cups can be attached to the bottom of one or more panels for adhering to a suitable floor. These can be place in positions corresponding approximately to those of binder clips 50, as illustrated in FIG. 7, or adjacent to corners where panels intersect. Such suction cups can be attached to the sides of the panels at appropriate positions so that the suction cups attach the barricade 10 to an elevator buck or other suitable structure.

In another embodiment, the sign or barricade 10 can be secured to a stake into the ground where it is the ground is grassy or unpaved. One or more loops that are attached to the sign or barricade 10 can be provided on the bottom of the panels for this purpose.

While the embodiment described herein includes three panels, it will be understood that other embodiments may have a different number of panels. For example, if only two panels are used, when viewed from above, the barricade would have a “V” shape, with each of the two panels being secured on one side to the elevator buck or frame, and another side secured to the other panel. More than three panels may be used, with only the end two panels being secured to the elevator buck or frame, and the other panels forming a polygonal shape having more than four sides, when viewed from above. Generally, two to five panels may be used. However, in certain circumstances, with the proper wall configuration, one relatively wide panel can be used from one side of the elevator to a wall, to enclose the space in front of the elevator doors. When used herein, the term plurality has the traditional meaning of two or more.

The sign disclosed herein has many advantages. One or more signs that may be needed at a site can be stored, while taking up only a very small space. The signs are of very low weight, and can easily be transported to places where they are needed to assure safety. Upon reaching the place where needed, the signs can be readily deployed by removing the elastic band and allowing the sign to pop-up and be unfolded into the configuration required for use. The signs can be readily attached to the places where needed using the integral magnetic tabs, with or without corresponding suction cups, as may be required. When attached to a structure for use, the tabs may be readily detached after the sign is no longer required. Then the sign can be collapsed and folded into a storage configuration, and secured with, for example, an elastic band. The collapsed and secured sign can be easily carried to a storage area, where it can be used when again needed. Alternatively, if no long required at a particular site, the low weight enables the sign to be shipped to a new site, easily and efficiently.

It will be understood that while a principal application of the sign disclosed herein is to warn people of hazardous areas, such as those that exist when an elevator is being repaired, the sign disclosed herein can be deployed in a variety of places and situations, including but not limited to those where the advantages disclosed above may be exploited. As shown in FIGS. 1, 2 and 3, the sign preferably has warnings thereon, which may be on each panel 12, 14 and 16 which alert people present to exercise caution and/or the reason for such caution, such as the fact that elevator maintenance is being conducted.

The barricade described herein may have a variety of heights. A preferred range is from one foot or eighteen inches to six feet, with a preferred height within that range of four feet.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The term “magnetic material” means any material that can be attracted to or will attract a magnet.

The terms “comprises” or “comprising” are to be interpreted as specifying the presence of the stated features, integers, steps or components, but not precluding the presence of one or more other features, integers, steps or components or groups thereof.

What is claimed is:

1. An apparatus for partitioning a space, comprising:
at least one panel arranged as a collapsible assembly; and
a set of fasteners for removable attachment of one or two of the panels to a structure so as to partition off the space in front of the structure.

2. The apparatus of claim 1, wherein the at least one or more panels are folded over one another when the apparatus is collapsed.

3. The apparatus of claim 2, wherein the panels are folded over one another to form a folded assembly, and the folded assembly is folded and twisted when the apparatus is collapsed

4. The apparatus of claim 1, wherein the fasteners each comprise:
at least one tab extending from an edge of a first of the plurality of fasteners; and
at least one tab extending from an edge of a second of the plurality of fasteners;
wherein each tab includes a magnetized material for removable attachment to the structure.

5. The apparatus of claim 1, further comprising:
at least one tab extending from an edge of a first of the plurality of fasteners;
at least one tab extending from an edge of a second of the plurality of fasteners; and
a plurality of suction cups for removable attachment to the structure, each suction cup including a magnetic material;
wherein each tab includes a magnetized material for removable attachment to one of the suction cups.

6. The apparatus of claim 1, wherein the fasteners each comprise:
at least one tab extending from an edge of a first of the plurality of fasteners; and
at least one tab extending from an edge of a second of the plurality of fasteners;
wherein each tab includes a fabric fastener.

7. The apparatus of claim 1, further comprising:
at least one tab extending from an edge of a first of the plurality of fasteners;
at least one tab extending from an edge of a second of the plurality of fasteners; and
a plurality of suction cups for removable attachment to the structure, each suction cup including a first fabric fastener;
wherein each tab includes a second fabric fastener for removable attachment to a first fabric fastener.

8. The apparatus of claim 1, wherein at least one panel has wording thereon.

9. The apparatus of claim 8, wherein the wording accomplishes at least one of alerting people to exercise caution and the reason caution is required.

10. The apparatus of claim 1, which serves as a barrier to discourage entry into the space.

11. The apparatus of claim 1, comprised of three panels.

12. The apparatus of claim 1, further comprising a band for maintaining the apparatus in a collapsed configuration.

13. The apparatus of claim 12, wherein the band is affixed to the apparatus.

14. The apparatus of claim 1, configured to be attached to and removed from an elevator door frame so that access is limited to the space in front of the door frame.

15. The apparatus of claim 14, comprised of three panels, wherein a first panel is attached to a first side of the door frame, a second panels is attached to a second side of the door frame opposite the first side, and a third panel is attached to the first panel along a first edge of the third panel and to the second panel along a second edge of the third panel.

16. The apparatus of claim 15, wherein the first panel and the second panel are configured so that the third panel is disposed in parallel to the door frame when the apparatus is attached to the door frame.

17. The apparatus of claim 1, wherein said plurality of panels comprises at least three panels.

18. The apparatus of claim 1, wherein the apparatus has a height of between eighteen inches and six feet.

19. The apparatus of claim 1, wherein the apparatus has a height of four feet.

20. The apparatus of claim 1, further comprising a stabilizing member at the bottom of at least one of the plurality of panels, the stabilizing member having a first portion contacting a floor on which the apparatus is placed and a second portion attached to one of the plurality of panels.

21. The apparatus of claim 1, further comprising suction cups attached to the bottom of one or more panels for adhering to a suitable floor.

22. The apparatus of claim 1, further comprising one or more loops attached to at least one of the panels adjacent a bottom of the panel, the loops being suitable for attaching to a stake in the ground.

23. The apparatus of claim 1, further comprising one or more first cords attached to the apparatus for fastening to the structure or to a suction cup attached to the structure.

24. The apparatus of claim 23, further comprising a second cord attached to the suction cup, the second cord being for attachment to one of the first cords.
